(19) United States
(12) Patent Application Publication
(10) Pub. No.: US 2006/0140843 A1
(43) Pub. Date: Jun. 29, 2006

(54) Macroporous structures for heterogeneous catalyst support

(76) Inventors: In-Kyung Sung, Daeduk-gu (KR); Dong-Pyo Kim, Yusung-gu (KR); Paul J.A. Kenis, Champaign, IL (US)

Correspondence Address: EVAN LAW GROUP LLC, 566 WEST ADAMS, SUITE 350, CHICAGO, IL, 60661, US

(21) Appl. No.: 11/022,281

(22) Filed: Dec. 23, 2004

(51) Int. Cl. B01J 27/22; B01J 27/24; B01J 21/04; B01J 23/02; C01B 3/04; C01B 3/02; C01B 6/24; C01B 21/00

(52) U.S. Cl. 423/351; 502/439; 502/177; 502/200; 423/644; 423/648.1; 423/658.2

(57) ABSTRACT

A catalyst support comprises a monolithic non-oxide material having a surface area per unit volume of at least 10⁵ m²/m³, and a pressure drop of at most 0.25 atm/mm.

### FEDERALLY SPONSORED RESEARCH OR DEVELOPMENT

The subject matter of this application may in part have been funded by DoD MURI program (administered by the Army Research Office) grant no. DAAD19-01-1-0582. The government may have certain rights in this invention.

### BACKGROUND

Porous solids with tailored pore characteristics have attracted considerable attention as selective membranes, photonic bandgap materials, and waveguides⁴⁻⁵. In addition, these high surface area materials are suitable as catalyst supports⁴.

Performing heterogeneous catalytic reactions in monolithic porous structures at the microscale has certain advantages. Heat and mass transfer fluxes are much larger at the microscale than at the macroscale as a result of the shorter distances and the larger surface-area-to-volume ratios^{6,7}. The heat transfer limitations that typically limit the reaction rates of many of the highly endothermic reactions catalyzed by heterogeneous catalysts, such as the steam reforming of hydrocarbons, at the macroscale can be greatly reduced by operating at the microscale. Additionally, the use of monolithic porous structures within microchannels is preferred over the traditionally used packed particle beds: packed particles settle as a result of vibrations and/or shock that are commonly encountered in portable devices, and flow of the reactants is often diverted around the particles, a phenomenon called channeling⁸. Channeling reduces the conversion efficiency for catalytic packed particles, a problem that is avoided when using a monolithic catalyst support.

The challenge in the fabrication of monolithic microscale structures as supports for heterogeneous catalysts is to combine within one material the properties of (i) high surface area per unit volume; (ii) compatibility with high temperatures, ideally >800° C.; and (iii) acceptable pressure drop. The requirement for high surface area per unit volume can be met in a highly porous material with interconnected pores. Unfortunately, obtaining such porous structures that also fulfill the pressure drop and thermal compatibility requirements has proven to be difficult.

Many of the monolithic high surface area porous materials reported to date are oxides prepared by flame pyrolysis or aqueous sol-gel techniques⁹⁻¹³, or carbon molecular sieves with surface areas per unit volume of 10⁹ m²/m³ created from silica templates^{14,15}. The low chemical and thermal stability of these materials, however, makes them inappropriate for many catalytic reactions. Others¹⁶⁻¹⁸ have fabricated porous silica and titania structures with surface areas per unit volume of 10⁵-10⁸ m²/m³ around a template, using either solid particles or supramolecular assemblies to form the template. Unfortunately, all these oxide materials lose their structural integrity below 800° C., which limits their applicability.

In contrast, non-oxide materials such as silicon nitrides are more promising due to their chemical and thermal stability at much higher temperatures. For example, Huppertz et al.¹⁹ have synthesized nitridosilicates with a zeolite-analogous silicon-nitride structure having 1 nm pores, a thermal stability up to 1600° C., and a surface area per unit volume on the order of 10⁹ m²/m³. This nanoporous structure, because of its small pores, would lead to large pressure drops within a reactor if used as a monolithic catalyst support. Moreover, methods to increase the pore size in these nitridosilicate structures, and thereby decrease the pressure drop, are not available¹⁹.

Similarly, non-oxide materials such as silicon carbide (SiC) and silicon carbonitride (SiCN) exhibit high thermal and chemical stability, yet methods to obtain SiC or SiCN monoliths with tailored porous structures have not been reported to date, although recently the fabrication of macroporous SiC as a powdery product using sacrificial templates has been reported²⁰. Others have shown the fabrication of non-oxide ceramic microscale structures via replica molding²¹.

Microreactors for the steam reforming of fuel to produce hydrogen for fuel cells have been described³². One limitation arising from these devices was found to be the high pressure drops required to maintain the desired reactant feed rates through the microchannel network based packed catalyst bed of the microreactor. These feed rates are unsustainable due to material strength limitations.

Porous membranes having a highly ordered three-dimensional structure have been fabricated. Some of these structures were formed from oxides materials. However, free-standing structures in which the template had been removed could not be formed because they were too fragile, and hence actual porous structures from ceramic materials were not formed³³.

### BRIEF SUMMARY

In a first aspect, the present invention is a method of forming a catalyst support, comprising heating a structure comprising a cured precursor to form the catalyst support. The structure comprises packed template particles having a particle diameter of 10 nm to 100 μm, and the catalyst support comprises a monolithic non-oxide material.

In a second aspect, the present invention is a catalyst support, comprising a monolithic material having a void fraction of at least 0.5, and a pore diameter of 10 nm to 100 μm. The material comprises at least one member selected from the group consisting of carbides and nitrides.

In a third aspect, the present invention is a catalyst support, comprising a monolithic material having surface area per unit volume of at least 10⁵ m²/m³, and a pressure drop of at most 0.25 atm/mm. The material retains its structural integrity at a temperature of 800° C.

In a fourth aspect, the present invention is a catalyst support, comprising a monolithic non-oxide material having surface area per unit volume of at least 10⁵ m²/m³, and a pressure drop of at most 0.25 atm/mm.

### DEFINITIONS

The phrase “retains structural integrity” means that when the material or structure is kept at the specified temperature for 1 hour under an inert gas (such as Ar), there is a loss of at most 5% of the surface area.

The phrase “retains oxidative chemical stability” means that when the material or structure is kept at the specified temperature for 1 hour under air, there is a loss of at most 5% of the weight, and there is a reduction in the amount of the desired phase, as measured by X-ray powder diffraction, of at most 2%.

The phrase “retains reductive chemical stability” means that when the material or structure is kept at the specified temperature for 1 hour under an ammonia, there is a loss of at most 5% of the weight, and there is a reduction in the amount of the desired phase, as measured by X-ray powder diffraction, of at most 2%.

The term “microscale” means that the object has at least one dimension which is at most 10 cm.

The term “pore diameter” of a material means the average diameter of circles, with each circle having the same area as the observed area of each pore of a center cross-section of the material, as measured by a scanning electron microscope (SEM).

The term “particle diameter” of a collection of particles means the average diameter of spheres, with each sphere having the same volume as the observed volume of each particle.

The term “surface area per unit volume” means the geometric surface area per unit volume as calculated, assuming that each pore is a spherical void, based on the pore diameter (as defined above) and number of pores observed, and assuming that the pore size and concentration is uniform throughout those portions of the structure prepared simultaneously and under the same conditions (including using the same template).

The term “void fraction” is a geometric void fraction calculated for a structure, assuming that each pore is a spherical void, based on the pore diameter (as defined above) and number of pores observed, and assuming that the pore size and concentration is uniform throughout those portions of the structure prepared simultaneously and under the same conditions (including using the same template).

The term “packed” means that the particles of the sacrificial material are in physical contact with each other.

The term “non-oxide” includes carbides, nitrides, borides, oxynitrides, oxycarbides, etc., and excludes oxides such as silicon oxide, titanium oxide, etc.

The term “pressure drop” means the pressure drop as measured by the indirect method.

Pressure drop may be approximated by using a modified version of the Ergun equation⁸, using the pore diameter, surface area and void volume defined above. The modified Ergun equation is the following:

$$\frac{ⅆ P}{ⅆ z} = \frac{- G ( 1 - ɛ )}{ρ {d}_{p} {ɛ}^{3}} ( \frac{150 ( 1 - ɛ ) μ}{{d}_{p}} + 1.75 G )$$

where:

dP/dz is the pressure drop per unit length;

G is the superficial velocity (mass flow rate per unit area);

ε is the void fraction;

ρ is the density of the fluid;

dₚ is the pore size; and

μ is the viscosity of the fluid.

### BRIEF DESCRIPTION OF THE DRAWINGS

FIG. 1 is a schematic of the overall fabrication process for monoliths with tailored porous structures.

FIG. 2 contains SEM micrographs showing the different stages of the fabrication process: (a) Packed beds of polystyrene (PS) spheres (D=1 μm) in polydimethylsiloxane (PDMS) microchannels (20 μm×8 μm); (b) packed beds of PS spheres (D=1 μm) infiltrated with cured polyvinylsilazane (PVS) inside a 40 μm×8 μm microchannel; (c) SiCN microchannel replica and its 3-dimensionally interconnected pore structure comprising pores with a pore diameter of 1 μm (inset) formed by pyrolysis; (d) and (e) porous SiC monoliths with pores having a pore diameter of 1.5 μm and 40-50 nm, respectively, after pyrolysis and subsequent removal of the sacrificial SiO₂ spheres by etching with 10% HF solution; in the inset of (e) the ˜15 nm interconnecting windows can be seen.

FIG. 3 is an overall schematic of the integration of monolithic porous structures within a ceramic housing.

FIG. 4 is a schematic of a system for reforming fuel and generating electrical power.

FIG. 5 is a graph showing the conversion of NH₃ as a function of NH₃ flow rate for different temperatures.

FIG. 6(a) illustrates detail of the interdigitated channels, and the inlet to the channels, and exit channels.

FIG. 6(b) illustrates the channels to bridge the gap between the interdigitated channels and the exit channels illustrated in FIG. 6(a).

FIG. 7(a) and (b) are SEM micrographs of SiC porous structures after heat treatment at 1200° C. for 6 hrs under an air atmosphere.

### DETAILED DESCRIPTION

The present invention makes use of the discovery that monoliths of ceramic materials, especially non-oxide materials, such as SiC and SiCN, can be formed with tailored porous structures by using a template. These monoliths, having highly uniform and interconnected porous structures, resulting in low pressure drops, may be used as catalyst support structures, and are well suited for fuel reforming.

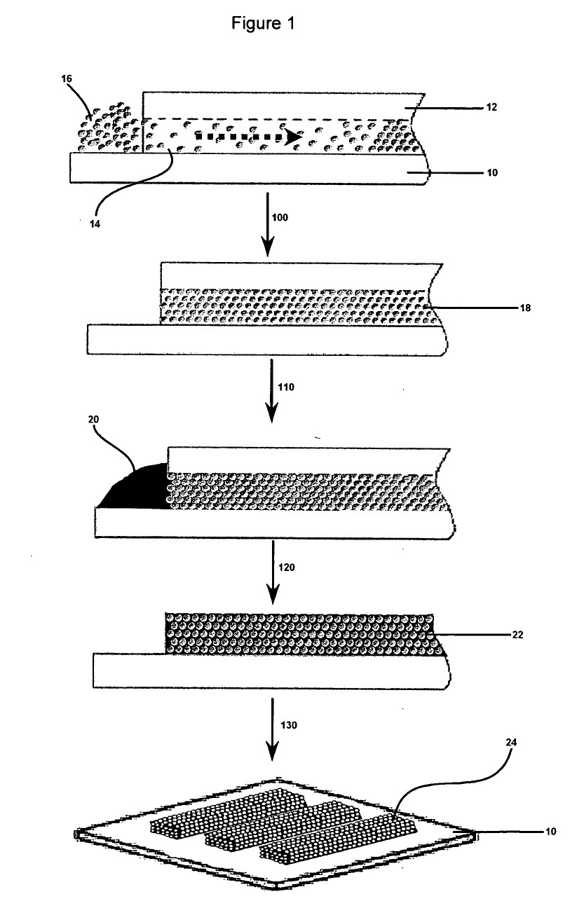

FIG. 1 shows the fabrication scheme for the synthesis of SiC and SiCN microchannel replicas with tailored pore structures. We adopted the micromolding in capillaries (MIMIC) method used previously for the synthesis of porous oxide materials²².

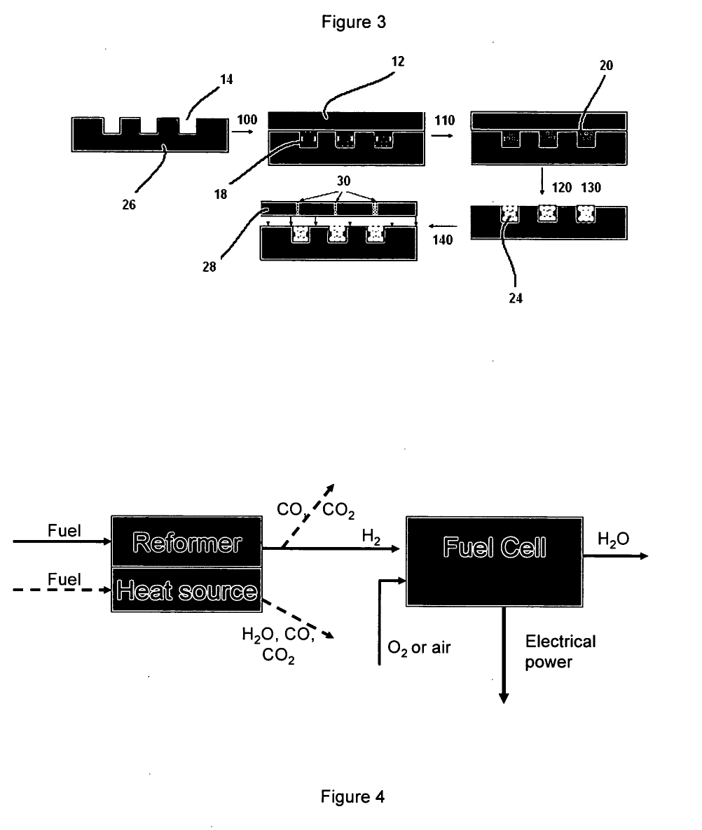

First, a channel 14 is formed, either by placing a mold 12 on a substrate 10, or by using a channel formed in a housing (see FIG. 3). A template 16 is packed into the channel (100). It is important the particles of the template are in contact with each other (i.e. packed), or the pores formed will not be interconnected. Preferably, the template particles are suspended in a solution, and are allowed to flow into the channel by capillary action and evaporation of the solvent at the far end of the channel. This results in highly ordered packing of the template particles (referred to a crystallized template particles).

Once the template is packed into the channel, the template is dried, forming the packed template 18. The voids of the packed template within the channel are then infiltrated with a precursor 20 (110). The precursor is then cured, typically by heating, and then the mold is removed, to form a cured precursor 22 containing the packed template (120). Finally, the cured precursor is pyrolyzed, converting the precursor into a ceramic 24 (130). If necessary, during 130, the template may be removed after pyrolysis (such as with a ceramic, metal, or other material that is stable during pyrolysis, for example silica) by chemical etching; however, when an organic-based template is used (for example, a polymer such as polystyrene) the template will burn off or decompose during pyrolysis and no etching is needed.

The template contains particles that are packed into the channel. Preferably, the particles have a particle diameter of 1 nm to 100 μm, more preferably from 40 nm to 10 μm, including 50 nm to 1.5 μm. This will result in a catalyst support having a pore diameter which corresponds to the particle diameter (i.e. a pore diameter of 1 nm to 100 μm, more preferably from 40 nm to 10 μm, or 50 nm to 1.5 μm, respectively). A variety of particles are available commercially, or may be prepared as described in U.S. Pat. No. 6,669,961. Preferably, the particles are suspended in a solvent, such as water, an alcohol (such as ethanol or isopropanol), another organic solvent (such as hexane, tetrahydrofuran, or toluene), or mixtures thereof. If necessary, a surfactant may be added to aid in suspending the particles, and/or the mixture may be sonicated.

Since the particles of the template are packed (i.e. they are in physical contact with each other), the monolith formed will have interconnecting pores, allowing gas to flow through the monolith. The void fraction of the monolith will in part depend on the size distribution of the particles, the shape of the particles, and the packing arrangement. For example, if the template particles all have exactly the same size and they are packed in a perfect close packed structure, the void fraction will be 0.74. The void fraction may be increased, for example, by adding second template particles, having a diameter small enough, and present in a small enough amount, to fit completely within the interstices of the lattice formed by the close packed larger template particles. Alternatively, the void fraction may be decreased, for example, by adding second template particle which are smaller than the closed packed template particles, but not small enough to fit within the interstices of the lattice. Preferably, the void fraction is at least 0.5, more preferably at least 0.7, most preferably at least 0.74.

The template particles may contain any material which may either be dissolved or etched away (while not removing the final catalytic support material), or a material which will decompose or evaporate during pyrolysis. A material which will at least partially decompose or evaporate during pyrolysis may be used, as long as any remaining material can be dissolved or etched away. Examples include polymers (such as polystyrene, polyethylene, polypropylene, polyvinylchloride, polyethylene oxide, copolymers thereof, and mixtures thereof), ceramic materials (such as silica, boron oxide, magnesium oxide and glass), elements (such as silicon, sulfur, and carbon), metals (such as tin, lead, gold, iron, nickel, and steel), and organic materials (such as pollen grains, cellulose, chitin, and saccharides).

The ceramic materials from which the support is formed preferably is a non-oxide ceramic. Preferably, the ceramic retains its structural integrity at a temperature of at least 600° C., more preferably at least 800° C., even more preferably at least 1000° C., most preferably at least 1800° C. Examples include nitrides, carbides and borides, such as silicon nitride, silicon oxynitride, boron nitride, transition metal nitrides (such as titanium nitride, niobium nitride, tantalum nitride, and zirconium nitride), silicon carbide, boron carbide, transition metal carbides (such as titanium carbide, niobium carbide, tantalum carbide, and zirconium carbide), and transition metal borides (such as niobium boride). Oxide ceramics are less preferred, and include silica (SiO₂), titania (TiO₂), and zirconia (ZrO₂). Once formed, the surface area per unit volume is preferably 10⁵ to 10⁸ m²/m³, and the void fraction is preferably at least 0.50, more preferably at least 0.74 (which corresponds to a close-packed arrangement of mono-dispersed spherical particles).

Precursor materials are selected based on the ceramic desired to form the monolith. The precursors must be curable to a solid intermediate that will remain solid during pyrolysis so that the structure imparted by the template will remain. A variety of precursors are known, such as polyvinylsilazane, borazines and borazine polymers, allylhydridopolycarbosilane, and colloidal precursors generated from transition metal halides reduced with n-C₄H₉Li in hexane³⁰. Other precursors are available³¹.

Catalyst may be applied to the surface (especially the interior surface) of the monolith by a variety of well know methods, including wet impregnation and vapor phase deposition. Any heterogeneous catalyst may be used, selected depending on the reaction to be catalyzed, such as Cu/ZnO for steam reforming of methanol, and Ni for steam reforming of hydrocarbons. Other catalysts, such as Ru, Fe, Pt and Pd, may also be used.

The fabrication of a reactor housing as part of an integrated microreactors for high temperature applications should take into account the following: first, the reactor housings should be fabricated out of high-density ceramic materials, enabling the microreactor to perform effectively at high temperatures (>800° C.) without leaking, decomposing, or losing its structural integrity; second, the reactor housing should also be non-deformed and crack-free. Deformation in the reactor housing can lead to structural warpage and cracking when operating at high temperatures. Suitable materials included metals, such as stainless steel and tungsten, and ceramics, such as the non-oxide ceramic suitable for the monolith and oxides ceramics including alumina, zirconia, titania and quartz.

The gelcasting forming method may be used to fabricate high-density ceramic structures that are non-deformed and crack-free²⁹. This inexpensive method is capable of fabricating complex-shaped microstructures with excellent results. First, a mixture of a ceramic powder is mixed with water, organic monomers and dispersant. After mixing, milling, removing any air bubbles, and chilling, this mixture is mixed with catalyst and initiator to form a slurry. A green body (the structure before thermal processing) is then formed from the slurry by replica molding. The green body is dried, the binder is removed, and the structure is sintered, to produce the high-density ceramic housing.

Reactor housings having microchannels with various sizes and shapes have now been fabricated successfully using the gelcasting forming method. Channel features as small as 100 μm have been fabricated.

The catalyst support structures may be integrated within the reactor housing in a variety of ways. In a first method, the ceramic reactor housing and the catalyst support structures are fabricated separately, followed by mounting of the catalyst support structures in the housing using a binder, and closing of the housing with a flat ceramic piece. In a second method, the ceramic housing is first fabricated using the gelcasting method, with the housing containing the channels in which the beads will be packed; for example, an interdigitated channel design may be used as the mold for the ceramic housing.

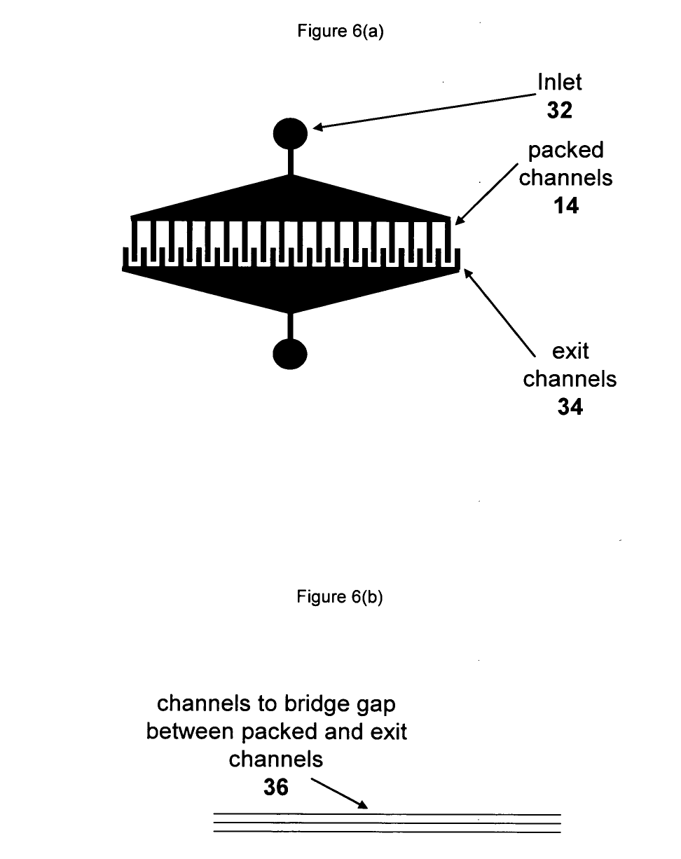

A schematic for the overall fabrication procedure is shown in FIG. 3. A mold 12 (preferably of poly(dimethylsiloxane), PDMS) having shallow channels perpendicular to the interdigitated channels 14 may be placed on top of the reactor housing 26 such that the shallow channels connect the channels on the inlet and the outlet sides; more detail of the interdigitated channels 14, an inlet 32 to the channels, and exit channels 34, are illustrated in FIG. 6(a), and the channels 36 to bridge the gap between the interdigitated channels and the exit channels is illustrated in FIG. 6(b). Alternatively, the housing may be formed as a single structure, including the lid (not illustrated). The shallow channels preferably have a height less than the diameter of the template so that the template structures are blocked form reaching the outlet while the water can flow through the shallow channels and reach the outlet. After proper clamping, the template solution is then injected at the inlet and the template then packs within the channels in the ceramic housing (100). After packing, the device is placed in a desiccator to remove all moisture. After removal of the moisture, the packed bed 18 is then infiltrated with the precursor 20 as described earlier (110). Curing, removal of the mold (120), and pyrolysis (130) are then carried out, resulting in the formation of the non-oxide monolithic porous structures 24 within the ceramic channels. The structures may then be impregnated with catalyst. To this ceramic housing, a ceramic lid 28 with inlets and outlets 30 is then bound, resulting in a gastight, highly dense ceramic housing, containing structures that function as a high surface area catalyst support (140).

A schematic of a system for reforming fuel and generating electrical power is illustrated in FIG. 4. As shown in the figure a first stream of a fuel (for example NH₃, an alcohol such as methanol, or a hydrocarbon fuel such as kerosene, gasoline or JP8) drives a heat source, which in turn heats a reformer (for example, a monolith of the present invention impregnated with a catalyst, within a housing) to cause the steam reforming of a second stream of the fuel, producing hydrogen (and by-products including carbon monoxide and carbon dioxide). This hydrogen may then be fed to one or more fuel cells, where it is reacted with oxygen (or another oxidizing agent) to generate electrical power. The heat source may be a small burner (which combusts the fuel to generate the heat), a catalytic fuel combustor, or a resistive heater (using electrical power rather than the fuel to generate the heat). The fuel cell then generates electrical power by oxidizing the hydrogen, preferably using oxygen as the oxidant. The gasses may be introduced into the reformer, heat source and/or fuel cell via tubing, such as alumina tubing. The fuel cell may be any type, preferably a parallel laminar flow fuel cell. In the steam reforming of an alcohol, steam is reacted with the alcohol in the presence of a catalyst to produce hydrogen, carbon monoxide and carbon dioxide. In the steam reforming of hydrocarbons, steam is reacted with the hydrocarbon in the presence of a catalyst to produce hydrogen, carbon monoxide and carbon dioxide.

### EXAMPLES

A PDMS mold was placed onto a flat substrate, here a silicon wafer, forming channels that are open at both ends. A solution containing either PS or SiO₂ spheres was then allowed to flow slowly into the channels from one end by capillary force. Once the solution had reached the other end of the channel, the spheres began to pack and the packing continued towards the inlet end. Growth of crystalline domains occurred as the sphere solution flowed toward the nucleation sites to replace the evaporated solvent at the outlet end²². After the packing process was completed, the solvent was removed completely, leaving behind a sacrificial template of close-packed spheres.

The void space between the spheres was then filled, again by capillary force, with a preceramic polymer, polyvinylsilazane (PVS) or allylhydridopolycarbosilane (AHPCS) for the formation of SiCN or SiC structures, respectively. The preceramic polymer, which also contained a small amount of thermal initiator, was then cured at 70° C. under a N₂ atmosphere. This low curing temperature allowed the use of a sacrificial template of packed PS beads, which have a glass transition temperature around 100° C.²³. After removal of the PDMS mold, the cured precursor was pyrolyzed for 1 hour at 800 to 1200° C. under an Ar atmosphere. The PS spheres decomposed during the early stages of the pyrolysis process, while SiO₂ spheres were etched away with a 10 vol % HF solution after pyrolysis. This procedure resulted in the formation of SiC or SiCN microchannel replica monoliths with a tailored inverted beaded porous structure. The higher void fraction of an inverted beaded structure (ε=0.74) as opposed to a beaded structure (ε=0.26) is a key advantage since it results in ˜190 times lower pressure drop per unit length (determined using the Ergun equation⁸).

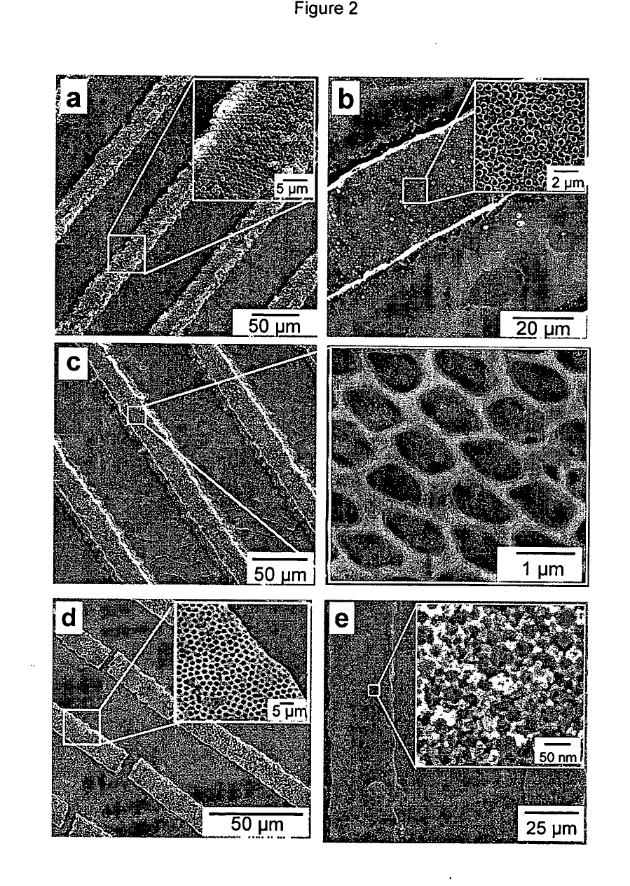

FIG. 2 depicts the various fabrication stages of inverted beaded SiC and SiCN porous monoliths using packed beds of PS or SiO₂ spheres as the sacrificial template. Highly crystalline domains of packed PS spheres (D=1 μm) in PDMS microchannels (20 μm×8 μm) are formed (FIG. 2a), which help to obtain the open, interconnected porous structures for the continuous flow microreactor application. Packing of PS spheres from ethanol instead of water resulted in worse structures due to the faster evaporation rate of ethanol. Additionally, quicker pressure-assisted filling of the channel led to worse packing as expected. Furthermore, the crystallinity of the packed SiO₂ spheres was lower than that of PS spheres because of more rapid settling rates of the denser SiO₂ spheres.

FIG. 2b shows a microchannel replica structure after infiltration of the void spaces between the spheres with the preceramic polymer PVS followed by thermal curing. The void spaces within the sacrificial beaded template are nicely filled.

When using packed beds of PS spheres as the sacrificial template, the spheres start to decompose at 300° C. during pyrolysis, leaving behind open, continuous pores. FIG. 2c shows a ceramic SiCN microchannel replica that is free of cracks and has uniform pores with 150-200 nm interconnecting windows for the 1 μm spheres used. Although the PS spheres are spherical, the resulting pores in the microstructure are elliptical and elongated in the channel flow direction. This is attributed to distortion due to higher stresses in the direction perpendicular to the channel walls. When a channel was filled with only preceramic polymer, a ceramic ‘rod’ with many cracks was obtained after curing and pyrolysis as a result of the expected 30% shrinkage²⁴. The spheres may, therefore, serve as a structural support during the early stages of pyrolysis by absorbing some of the shrinkage stresses. The approximate 5% lateral shrinkage observed within the porous structures further supports this explanation.

FIG. 2d and 2e show SiC microchannel replicas-with interconnected pores obtained using packed beds of 1.5 μm and 40-50 nm SiO₂ spheres, respectively, as the sacrificial template. The open, interconnected pores are obtained after etching in HF. Cracks are observed, however, in the microchannel replica structure due to excessive stresses between the harder, less compliant SiO₂ spheres and the ceramic precursor during the early stages of pyrolysis. In the inset of FIG. 2e the ˜15 nm interconnecting windows can be seen. The lower uniformity of the porous structure shown in FIG. 2e can be explained by the larger dispersity (40-50 nm) of the SiO₂ spheres used.

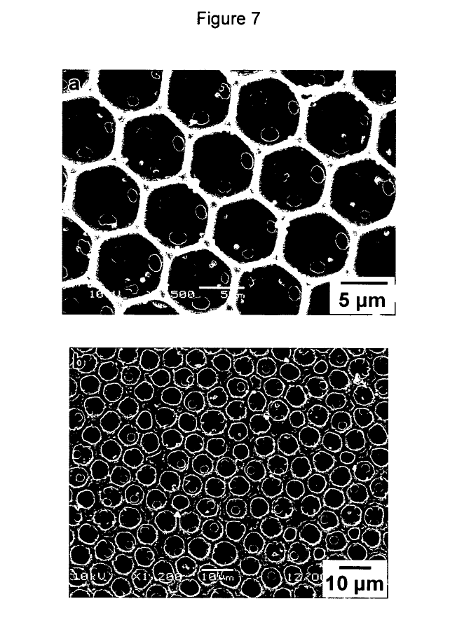

Thermogravimetric analysis (TGA) showed that the pyrolyzed samples did not lose weight when heated to 1000° C. in air, which is consistent with reports that pyrolysis of AHPCS and PVS in Ar forms amorphous SiC and SiCN, respectively²⁵. TGA resuls for a SiC porous structure heated up to 950° C. for 2 hours under air atmosphere showed on an approximately 0.07% weight loss. At 1250° C., amorphous SiC forms p-SiC crystallites, and at 1450° C., amorphous SiCN forms either p-SiC crystallites (in Ar) or a mixed crystalline phase with β-SiC, α-Si₃N₄, and β-Si₃N₄ in a N₂ atmosphere^{24,25}. These crystalline materials are all stable up to 1800° C. in air and up to 2000° C. in inert atmospheres, making them ideal for high temperature applications³. Porous SiCN and SiC monoliths exhibited no significant change in composition nor pore size after heating in air at 1200° C. for 6 hours. FIGS. 7(a) and (b) are SEM micrographs of SiC porous structures after heat treatment at 1200° C. for 6 hrs under an air atmosphere. The structures retain their open, interconnected pores with inverted beaded matrices after heat treatment, which indicates that they are stable at temperatures as high as 1200° C. under oxidizing environment. The XPS spectra (Si 2p spectra after peak deconvolution) of SiC porous structures before and after heat treatment at 1200° C. for 6 hours under air atmosphere are shown in the table below.

| | Before heat treatment | After heat treatment |
|---|---|---|
| SiC (%) | 88.1 ± 2.6 | 87.2 ± 1.3 |
| SiOC (%) | 10.6 ± 2.3 | 11.9 ± 1.5 |
| SiO₂ (%) | 1.3 ± 0.4 | 0.9 ± 0.2 |

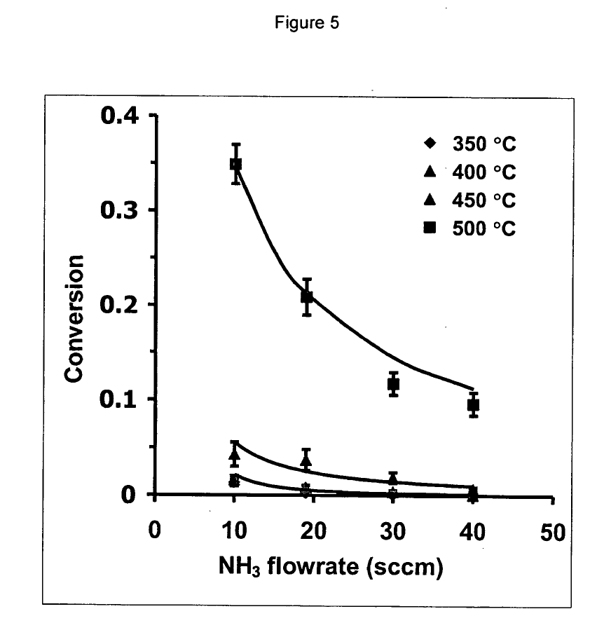

After the successful synthesis of SiC and SiCN inverted beaded structures with precisely tailored pore structures, they were tested as catalyst support structures for the reforming of ammonia (NH₃). The structures were coated with ruthenium catalyst via wet impregnation, calcination, and subsequent reduction in H₂, and then inserted into a stainless steel test fixture which served as a housing. FIG. 5 shows the conversion of NH₃ as a function of flow rate for temperatures between 350 and 500° C. measured at 50° C. increments. The NH₃ flow rates of 10 to 40 sccm correspond to residence times of 120 to 30 ms. As expected, the conversion increases with increasing temperature. The large increase in conversion from 450 to 500° C. is due to the Arrhenius dependence of the rate constant on temperature⁸. The dashed lines in the graph fit the conversion data assuming plug flow, constant temperature, no pressure drop, and first order kinetics with respect to NH₃. The theoretical pressure drop (from the Ergun equation⁸ while assuming T=500° C., a flow rate of 40 sccm NH₃ at 1 atm.) for the 2 mm tall cylindrical monolith with a diameter of 7 mm and 10 μm pores is only 0.008 atm., which confirms that the inverted beaded porous monoliths reported here indeed have a high surface area while exhibiting tolerable pressure drops. Even for a monolith with the same overall dimensions but having pores with a pore diameter as small as 1 μm, the pressure drop would be only 0.5 atm.

The ammonia reforming experiments performed here were limited to 500° C. because stainless steel is known to catalyze NH₃ composition at higher temperatures²⁶, making it difficult to separate the conversion due to steel catalysis from the overall conversion. Once these porous structures are integrated within non-porous ceramic housings²⁷, conversion data at temperatures as high as 1100° C. can be obtained. Conversion is expected to be much higher at higher temperatures, and lower residence times will be required to attain equilibrium conversion using SiC or SiCN porous structures.

Methods

Microchannel Structures. A PDMS mold with microchannel structures was produced by replica molding of a master obtained through photolithography²⁸. After removal of the PDMS mold from the master, the mold was cut such that both ends of the microchannels were open to the atmosphere. The PDMS mold was placed in contact with a Cr-coated Si wafer which provided the fourth wall for the microchannels. Cr was sputtered onto the Si wafer to prevent adhesion of the wafer to the SiC and SiCN structures.

Creating Packed Beds of Beads. Solutions of 0.06 to 10 μm PS beads (Polysciences) were obtained by mixing 1 ml of the PS bead solution with 0.1 ml of 5 wt % surfactant (Pluronic P123, BASF) in D.l. water. Solutions of 1.5 and 0.5 μm silica spheres were prepared by adding 3 g of spheres (Lancaster) to 10 ml ethanol, followed by sonication for 40 min. (Branson 3510). Solutions of nano-sized spheres (Snowtex 50L, 20L, and ZL, with diameters of 20-30 nm, 40-50 nm, and 70-100 nm, respectively) were used as received. A drop of 5-10 μl of a PS or silica sphere solution was placed at one end of each channel, each of different dimensions (20-80 μm wide, 2-8 μm high, and 5-7 mm long), and left for 12 hrs to complete the packing process. After completion of the packing process, the PDMS mold with microchannels of packed PS or silica beaded beds was dried at 40° C. under vacuum for 24 hrs.

Creating Inverted-Beaded Structures of SiC and SiCN. The SiC and SiCN precursor solution contained 3-5 wt % of the thermal initiator, 1,1-bis(tert-butylperoxy)-3,3,5-trimethylcyclohexane (92%, Aldrich) in allylhydridopolycarbosilane (SP matrix, Starfire Systems), or in polyvinylsilazane (KiON VL20, KiON Corporation), respectively. In some cases the viscosity of the SP matrix mixture was reduced by dilution with tetrahydrofuran (THF) to facilitate infiltration. Infiltration of the packed beds of beads within microchannels with the precursor solution was carried out in a glove bag under a N₂ atmosphere. Twenty-five microliters of precursor solution was placed at one end of the microchannels, and the PDMS mold was left in the glove bag for 2 hrs. After the infiltration process was completed, the PDMS mold was placed inside an airtight container that could be connected to a N₂ stream. The closed container was transferred from the glove bag to a hot plate, and connected to a N₂ stream without any exposure to air. The curing process was carried out using a hot plate at 70° C. under a N₂ atmosphere for 12 hrs. After completion of the curing process, the container was closed, disconnected from the N₂ stream, and transferred back to the glove bag that was under a N₂ atmosphere. The PDMS mold was then either peeled away or removed by dissolution in 1.0 M tetrabutyl ammonium fluoride (TBAF) in THF for 20 minutes. Pyrolysis was carried out in a tube furnace (HTF5500 Series, Lindberg/Blue M) under an Ar atmosphere by heating at a rate of 180° C./hr to 1200° C. and holding at 1200° C. for 1 hr. Due to the instrumental limitation, the cooling rate could not be controlled.

Catalyst Deposition. Ru catalyst was deposited on the high surface area structures by impregnation with 0.96 wt % ruthenium (Ill) acetylacetonate (97%, Aldrich) in 2,4-pentanedione (99+%, Aldrich). After drying, the structure was calcined in air at 580° C. in the tube furnace for 3 hours. The structure was then mounted inside a stainless steel holder using ceramic binder (Ceramabond 569, Aremco) and placed within a stainless steel test fixture in the tube furnace. The catalyst was then reduced using 10% H₂ in Ar at 500 OC for 5 hours. Reactants and products were led into and out of the test fixture through stainless steel tubing attached with Swagelok connections.

Fuel Reforming Tests. The flow of NH₃ (anhydrous, Matheson Gas Products) through the porous structure inside the test fixture was controlled using a mass flow controller (1479A MASSFLO® Controller, MKS Instruments), while the temperature of the stainless steel test fixture with mounted porous structure was controlled inside the tube furnace. Gas chromatography/mass spectrometry (GC/MS) (Thermo Finnigan TRACE DSQ™ Single Quadrupole GC/MS) was used to measure the conversion of NH₃ into N₂ and H₂. For each flow rate of NH₃, the conversion data was taken after increasing the temperature of the furnace from 350 to 500° C. at 50° C. increments. The average conversion and its standard deviation were obtained from at least 3 measurements after steady state operation was reached.

Experimental setup for pressure drop determination by the indirect method:

To experimentally determine the pressure drop as a function of flow rate through the inverted beaded structures, the indirect method is used: a syringe pump is used to introduce fluid into a fluidic manifold. The manifold has one inlet (from the syringe pump) and two outlets: the inverted beaded structure is placed in one outlet channel, and the other outlet channel is rectangular channel and of known dimensions.

When the fluid passes through the manifold and splits between the two outlets, the ratio of the volumetric flow rates through the two different channels (the inverted beaded structure and the rectangular channel) will automatically adjust such that the pressure drop through both of the pathways is identical since both pathways are open to the atmosphere at the outlet and both originate at the same junction. The flow rate through each pathway will be different due to their differing respective fluidic resistances. These individual flow rates can be measured by collecting fluid (e.g. water) at each individual outlet with a vial over a certain period of time. Simply weighing the vials allows for determination of the volumetric flow rate through each pathway.

The actual pressure drop through the rectangular pathway can then be calculated using a standard equation for the pressure drop through a rectangular channel as a function of the channel geometry, the volumetric flow rate, and the viscosity of the fluid. This calculated pressure drop will be the same as that for the pathway containing the inverted beaded structure. Using this pressure drop as well as the experimentally measured flow rate for the pathway with the inverted beaded structure (determined above) one can determine a pressure drop-flow rate relation.

### REFERENCES

1. Arana, L. R., Schaevitz, S. B., Franz, A. J., Jensen, K. F. & Schmidt, M. A. A microfabricated suspended-tube chemical reactor for fuel processing. The Fifteenth IEEE Intemational Conference on Micro Electro Mechanical Systems 232-235 (2002).
2. Armor, J. N. & Martenak, D. J. Studying carbon formation at elevated pressure. Applied Catalysis A: General 206, 231-236 (2001).
3. STAR FIRE SYSTEMS™ home page at www.starfiresystems.com (2004).
4. Gates, B. & Xia, Y. Fabrication and characterization of chirped 3D photonic crystals. Adv. Mater. 12, 1329-1332 (2000).
5. Park, S. H. & Xia, Y. Fabrication of three-dimensional macroporous membranes with assemblies of microspheres as templates. Chem. Mater. 10, 1745-1747 (1998).
6. Ameel, T. A., Warrington, R. O., Wegeng, R. S. & Drost, M. K. Miniaturization technologies applied to energy systems. Energy Convers. Mgmt. 38, 969-982 (1997).
7. Jensen, K. F. Microchemical systems: status, challenges, and opportunities. AlChE Joumal 45, 2051-2054 (1999).
8. Fogler, H. S. Elements of Chemical Reaction Engineering. (Prentice Hall, New Jersey, 1999).
9. Weitkamp, J. Zeolites and catalysis. Solid State Ionics 131, 175-188 (2000).
10. Corma, A. From microporous to mesoporous molecular sieve materials and their use in catalysis. Chem. Rev. 97, 2373-2419 (1997).
11. Velev, O. D., Jede, T. A., Lobo, R. F. & Lenhoff, A. M. Porous silica via colloidal crystallization. Nature 389, 447 (1997).
12. Wijnhoven, J. E. G. J. & Vos, W. L. Preparation of photonic crystals made of air spheres in titania. Science 281, 802-804 (1998).
13. Subramania, G., Constant, K., Biswas, R., Sigalas, M. M. & Ho, K.-M. Optical photonic crystals fabricated from colloidal systems. Appl. Phys. Let. 74, 3933-3935 (1999).
14. Ryoo, R., Joo, S. H. & Jun, S. Synthesis of highly ordered carbon molecular sieves via template-mediated structural transformation. J. Phys. Chem. 103, 7743-7756 (1999).
15. Yoon, S. B., Kim, H. Y. & Yu, J.-S. Synthesis of highly ordered Nanoporous carbon molecular sieves from silylated MCM-48 using divinylbenzene as precursor. Chem Commun., 559-560 (2001).
16. Yang, P. et al. D. Patterning porous oxides within microchannel networks. Adv. Mater. 13, 427-431 (2001); U.S. Pat. No. 6,541,539.
17. Trau, M. et aL. Microscopic patterning of orientated mesoscopic silica through guided growth. Nature 390, 674-676 (1997).
18. Gates, B., Yin, Y. & Xia, Y. Fabrication and characterization of porous membranes with highly ordered three-dimensional periodic structures. Chem. Mater. 11, 2827-2836 (1999).
19. Huppertz, H. & Schnick, W. Ba₂Nd₇Si₁₁N₂₃— A nitridosilicate with a zeolite-analogous Si—N structure. Angew. Chem. Int Ed. Engl. 36, 2651-2652 (1997).
20. Sung, I.-K., Yoon, S.-B., Yu, J.-S. & Kim, D.-P. Fabrication of macroporous SiC from templated preceramic polymers. Chem. Commun. 1480-1481 (2002).
21. Yang, H., Deschatelets, P., Brittain, S. T. & Whitesides, G. M. Fabrication of high performance ceramic microstructures from a polymeric precursor using soft lithography. Adv. Mater. 13, 54-58 (2001).
22. Kim, E., Xia, Y. & Whitesides, G. M. Micromolding in capillaries: applications in materials science. J. Am. Chem. Soc. 118, 5772-5731 (1996); U.S. Pat. No. 6,355,198.
23. Technical Data Sheet 238 Polystyrene Microspheres: Frequently Asked Questions (Polysciences, Inc., 2001).
24. Product information sheet for KION® VL20 Polysilazane (KiON Corp., 2004); Product list KiON® CERASET® Polyureasilazane and KiON® VL20 Polysilazane (KiON Corp., 2001).
25. Kroke, E. et al. Silazane derived ceramics and related materials. Mater. Sci. Eng. R-Reports 26, 97-199 (2000).
26. Arabczyk, W. & Zamlynny, J. Study of the ammonia decomposition over iron catalysts. Catalysis Letters 60, 167-171 (1999).
27. Christian, Mitchell, M., Kenis, P. J. A. Manuscript in preparation.
28. Duffy, D. C., McDonald, J. C., Schueller, O. J. A. & Whitesides, G. M. Rapid prototyping of microfluidic systems in poly(dimethylsiloxane).

Anal. Chem. 70, 4974-4984 (1998).
29. Omatete, O. O., Janney, M. A., and Nunn, S. D. Gelcasting: From Laboratory Development Toward Industrial Production J. Euro. Ceram. Soc. 17, 407-413 (1997).
30. Chang, Y.-H. et al. Syntheses of nano-sized cubic phase early transition metal carbides from metal chlorides and n-butyllithium J. Mater. Chem. 12 (8) 2189-2191 (2002).
31. Sieber, H. Manufacture of biomorphous TiC-based ceramics Ceramic Engineering and Science Proceedings: 27th Annual Cocoa Beach Conference on Composites, Advanced Ceramics, Materials, and Structures: B 24 (3) 135-140 (2003).
32. Pattekar, A.V., Kothare, M.V. Fuel processing microreactors for hydrogen production in micro fuel cell applications 7th Intemational Conference on Microreaction Technology (IMRET-7), Lausanne, Switzerland (Sep. 7-10, 2003).
33. Gates, B., Yin, Y., Xia, Y. Fabrication and Characterization of Porous Membranes with Hightly Ordered Three-Dimensional Periodic Structures Chem. Mater. 11, 2827-2836 (1999).

1. A catalyst support, comprising a monolithic non-oxide material having a surface area per unit volume of at least 10⁵ m²/m³, and a pressure drop of at most 0.25 atm/mm.

2. The catalyst support of claim 1, wherein the surface area per unit volume is 10⁵ m²/m³ to 10⁸ m²/m³.

3-6. (canceled)

7. The catalyst support of claim 1, wherein the non-oxide material has a pore diameter of 10 nm to 100 μm.

8-10. (canceled)

11. The catalyst support of claim 1, wherein the non-oxide material has a void fraction of at least 0.74.

12-13. (canceled)

14. The catalyst support of claim 1, wherein the non-oxide material retains structural integrity at a temperature of 1800° C.

15. A catalyst support, comprising a monolithic material having surface area per unit volume of at least 10⁵ m²/m³, and a pressure drop of at most 0.25 atm/mm, wherein the material retains structural integrity at a temperature of 800° C.

16-20. (canceled)

21. The catalyst support of claim 15, wherein the material comprises at least one member selected from the group consisting of carbides and nitrides.

22. The catalyst support of claim 15, wherein the material has a pore diameter of 10 nm to 100 μm.

23-24. (canceled)

25. The catalyst support of claim 15, wherein the material has a void fraction of at least 0.7.

26. (canceled)

27. A catalyst support, comprising a monolithic material having a void fraction of at least 0.5, and a pore diameter of 10 nm to 100 μm, wherein the material comprises at least one member selected from the group consisting of carbides and nitrides.

28. The catalyst support of claim 27, wherein the material comprises silicon carbide or silicon carbonitride.

29-31. (canceled)

32. The catalyst support of claim 28, wherein the material has a surface area per unit volume of at least 10⁵ m²/m³.

33. The catalyst support of claim 28, wherein the material has a pressure drop of at most 0.25 atm/mm.

34-36. (canceled)

37. The catalyst support of claim 1, further comprising a ceramic housing surrounding the monolithic material.

38. The catalyst support of claim 37, wherein the housing comprises an oxide.

39. (canceled)

40. The catalyst support of claim 1, further comprising a catalyst on the monolithic material.

41. The catalyst support of claim 40, wherein the catalyst comprises at least one member selected from the group consisting of Ru, Fe, Ni, Pt and Pd.

42. The catalyst support of claim 15, further comprising a ceramic housing surrounding the monolithic material.

43-51. (canceled)

52. A method of forming a catalyst support, comprising:
heating a structure comprising a cured precursor to form the catalyst support;
wherein the structure comprises packed template particles having a particle diameter of 10 nm to 100 μm, and the catalyst support comprises a monolithic non-oxide material.

53-73. (canceled)

74. A method of carrying out a chemical reaction, comprising passing reactants into a catalyst support, to form products;
wherein the catalyst support comprises a monolithic ceramic material having a surface area per unit volume of at least 10⁵ m²/m³, and a pressure drop of at most 0.25 atm/mm.

75-85. (canceled)
